(19) United States
(12) Patent Application Publication
(10) Pub. No.: US 2015/0261068 A1
(43) Pub. Date: Sep. 17, 2015

(54) STROBE DEVICE AND IMAGING DEVICE PROVIDED WITH STROBE DEVICE

(71) Applicant: Panasonic Intellectul Property Management Co., Ltd ., Osaka (JP)

(72) Inventors: Kazuhiko Ooyama, Hyogo (JP); Toshiaki Takenaka, Osaka (JP)

(21) Appl. No.: 14/418,476

(22) PCT Filed: Aug. 19, 2013
(86) PCT No.: PCT/JP2013/004889

§ 371 Date: Jan. 30, 2015

(30) Foreign Application Priority Data
Aug. 20, 2012 (JP) 2012-181482

(51) Int. Cl. G03B 15/06; H04N 5/225; G03B 15/05

(52) U.S. Cl. CPC G03B 15/06; G03B 15/05; H04N 5/2256; G03B 2215/0521; G03B 2215/0585

(57) ABSTRACT

A strobe device of the present invention has a strobe body unit, a light-emitting unit rotatably coupled to the strobe body unit, a variable mechanism configured to change an angle and an orientation of the light-emitting unit with respect to the strobe body unit, a driving unit configured to drive the variable mechanism, and a control section configured to control the driving unit. The control section includes modes for selecting a particular one from among a plurality of reflective objects, and an arithmetic operation unit configured to calculate a bounce angle of the light-emitting unit with respect to the reflective object selected by using the modes. The control section controls the driving unit to cause an angle of the light-emitting unit to be the bounce angle. As a result, the strobe device which is ready to perform bounce photography without missing a chance for a good shot can be realized.

### TECHNICAL FIELD

The present invention relates to an irradiating direction adjustable strobe device that can change an angle and an orientation of a light-emitting unit and an imaging apparatus provided with the strobe device.

### BACKGROUND ART

Conventionally, for the purpose of obtaining more natural photographs, imaging apparatuses have been configured to use bounce photography which is a technique of capturing an image by causing a light-emitting unit of a strobe device to emit light and irradiate a reflective object such as a ceiling or a wall to diffuse the light so that a subject is indirectly illuminated by the diffused light.

Specifically, the bounce photography is a technique of capturing a subject image not by directing a irradiating surface of the light-emitting unit of the strobe device toward the subject but by directing the irradiating surface in a desired direction toward the reflective object such as a ceiling or a wall to cause the light emitted from the strobe device to be reflected from the reflective object and to illuminate the subject.

Then, there has been proposed a configuration of a conventional strobe device to automatically control a bounce angle formed between a capturing direction which is an optical axis direction of a capturing lens and a irradiating direction in which irradiation is performed, (a desired direction toward the reflective object) by using a control section of the strobe device (see, for example, PTL1). It is described in PL1 that the strobe device with the above described configuration can indirectly irradiate the subject by always directing the light-emitting unit toward a reflective object during the irradiation.

In addition, the strobe device described in PL1 measures the distance with autofocus by directing the capturing lens of the imaging apparatus toward a ceiling (a reflective object), and the subject respectively and sets the bounce angle based on distances from the reflective object and the subject to capture the subject.

It should be noted that the optimum condition of the bounce photography is not limited to the case where a ceiling is used as the reflective object. For example, it is advantageous to perform the bounce photography by using a wall and the like as the reflective object in some cases.

However, the strobe device described in PL1 does not assume that the strobe device switches the reflective object. As a result, the strobe device described in PL1 is unable to perform the optimum bounce photography by using an optional reflective object such as a wall.

### CITATION LIST

### Patent Literature

PTL1: Unexamined Japanese Patent Publication No. 2009-163179

### SUMMARY OF THE INVENTION

In order to solve the above described problem, the present invention is a strobe device for bounce photography which is a technique of capturing an image of a subject by irradiating a reflective object with strobe light to irradiate the subject with the reflected light. The strobe device has a strobe body unit, a light-emitting unit rotatably coupled to the strobe body unit, a variable mechanism configured to change an angle and an orientation of the light-emitting unit with respect to the strobe body unit, a driving unit configured to drive the variable mechanism, and a control section configured to control the driving unit. The control section includes modes for selecting a particular one from among a plurality of reflective objects, and an arithmetic operation unit configured to calculate a bounce angle of the light-emitting unit with respect to the reflective object selected by using the modes. The control section controls the driving unit to cause the angle of the light-emitting unit to be the bounce angle. As a result, the imaging apparatus is ready to perform bounce photography without missing a chance for a good shot. Therefore, the imaging apparatus which is able to capture an image of a subject in a more preferable state can be realized.

Further, the imaging apparatus of the present invention has the above described strobe device. As a result, the imaging apparatus is ready to perform bounce photography by using an optional reflective object. Therefore, the imaging apparatus which is able to capture a favorable image of a subject or to capture an image of a subject in more preferable irradiating conditions of strobe light can be realized.

### BRIEF DESCRIPTION OF DRAWINGS

FIG. 1 is a block diagram illustrating a configuration of an imaging apparatus according to an exemplary embodiment of the present invention;

FIG. 2 is a side view of a strobe device according to the exemplary embodiment.

FIG. 3 is a top view of the strobe device according to the exemplary embodiment.

FIG. 4A is a diagram illustrating an up and down irradiation range (a vertical irradiation range) that can be set to the strobe device according to the exemplary embodiment.

FIG. 4B is a diagram illustrating a left and right irradiation range (a horizontal irradiation range) that can be set to the strobe device according to the exemplary embodiment.

FIG. 5 is a conceptual diagram illustrating an interior of a room in which bounce photography is performed with the strobe device according to the exemplary embodiment.

FIG. 6A is a diagram illustrating a vertical-direction angle of a light-emitting unit of the strobe device according to the exemplary embodiment in measuring a first distance.

FIG. 6B is a diagram illustrating a vertical-direction angle of the light-emitting unit of the strobe device according to the exemplary embodiment in measuring a second distance.

FIG. 6C is a diagram illustrating a vertical-direction angle of the light-emitting unit of the strobe device according to the exemplary embodiment in performing the bounce photography.

### DESCRIPTION OF EMBODIMENT

A strobe device according to an exemplary embodiment of the present invention and an imaging apparatus provided with the strobe device will be described below with reference to the drawings. It should be noted that the exemplary embodiment below is an example that embodies the present invention and is not intended to limit a technical scope of the present invention.

### EXEMPLARY EMBODIMENT

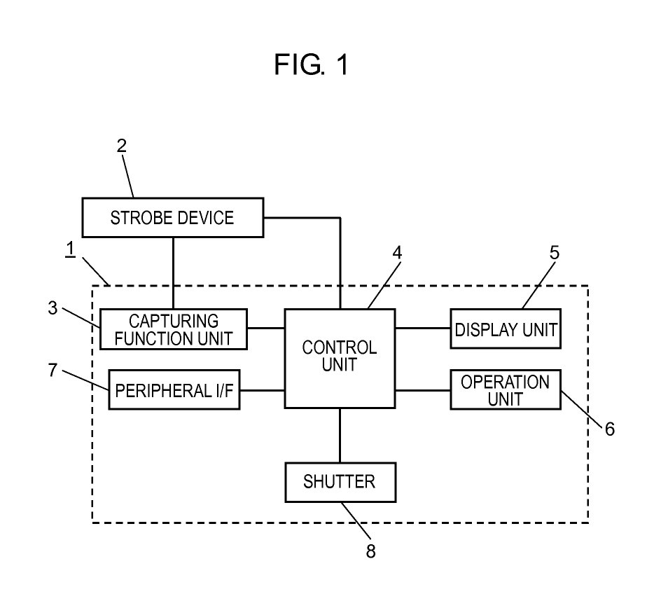

The strobe device according to the exemplary embodiment of the present invention and the imaging apparatus provided with the strobe device will be described below with reference to FIG. 1 to FIG. 4B.

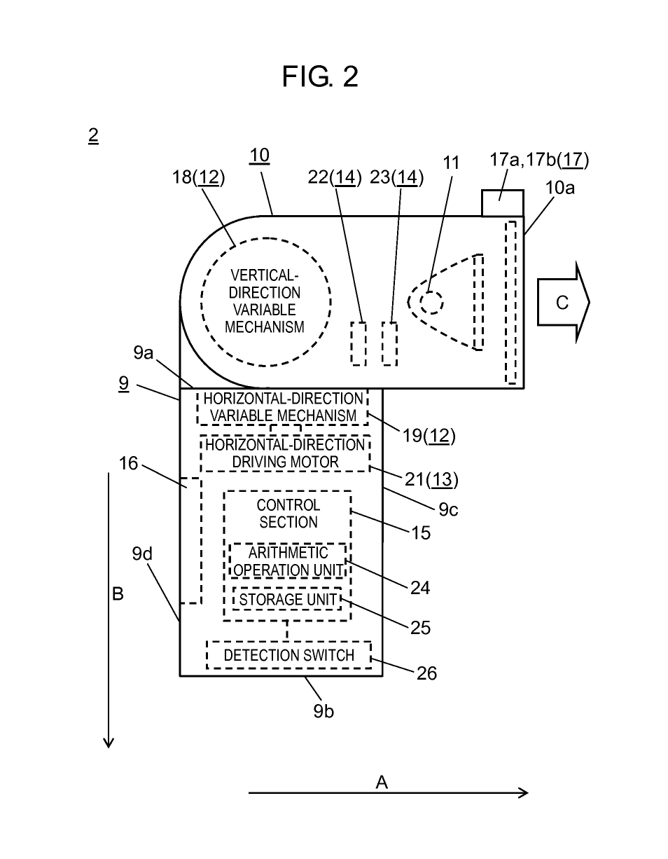

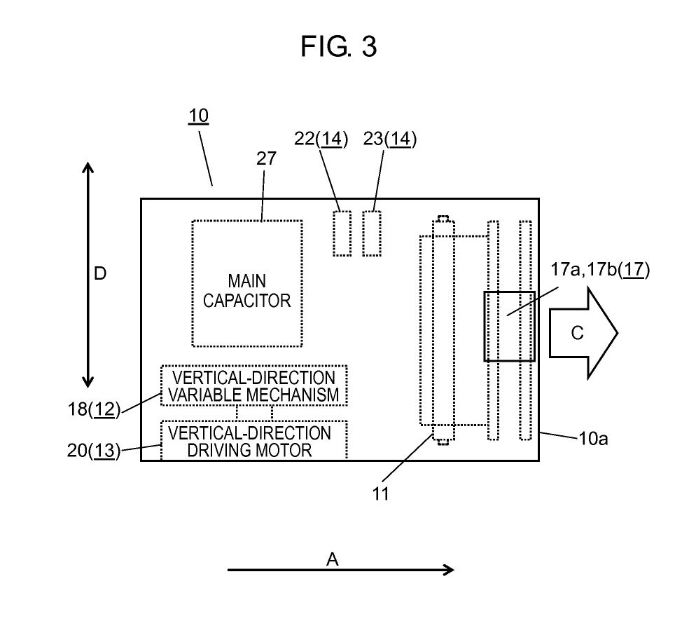

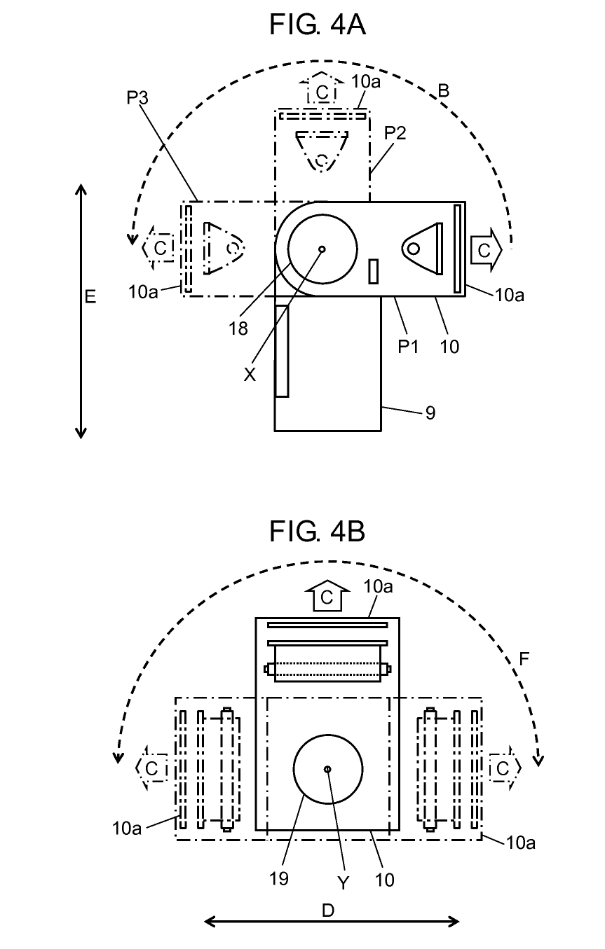

FIG. 1 is a block diagram illustrating a configuration of the imaging apparatus according to the exemplary embodiment of the present invention. FIG. 2 is a side view of the strobe device according to the exemplary embodiment. FIG. 3 is a top view of the strobe device according to the exemplary embodiment. FIG. 4A is a diagram illustrating an up and down irradiation range (a vertical irradiation range) that can be set to the strobe device according to the exemplary embodiment. FIG. 4B is a diagram illustrating a left and right irradiation range (a horizontal irradiation range) that can be set to the strobe device according to the exemplary embodiment.

As illustrated in FIG. 1, imaging apparatus 1 of the present exemplary embodiment includes capturing function unit 3 configured to capture at least an image of a subject, control unit 4, display unit 5, operation unit 6, peripheral I/F (Interface) 7, and shutter 8. Meanwhile, imaging apparatus 1 is detachably provided with (in a mountable manner) strobe device 2 configured to irradiate a subject with strobe light. Control unit 4 controls strobe device 2 and capturing function unit 3. Display unit 5 displays a captured subject image and the like. Operation unit 6 switches setting items of capturing conditions and on-off of a power supply. Peripheral I/F 7 inputs and outputs image data to and from a peripheral device. Shutter 8 is operated by a user who wants to cause strobe device 2 to emit light to capture an image of a subject.

In addition, as illustrated in FIG. 2 and FIG. 3, strobe device 2 of the present exemplary embodiment includes at least strobe body unit 9 which is made of, for example, a rectangular housing, light-emitting unit 10, variable mechanism 12, angle detection unit 14, control section 15, operating unit 16, and distance sensor 17. Light-emitting unit 10 is rotatably coupled to strobe body unit 9 and houses, for example, flash discharge tube 11. Then, light-emitting unit 10 causes flash discharge tube 11 to emit light by using, for example, electric energy supplied from main capacitor 27 and radiates the emitted light to outside. Variable mechanism 12 allows light-emitting unit 10 to change an angle and an orientation. Driving unit 13 drives variable mechanism 12. Angle detection unit 14 detects an angle of light-emitting unit 10 with respect to strobe body unit 9. Control section 15 controls strobe device 2. Operating unit 16 is provided on, for example, back side 9d of strobe body unit 9 and performs such operations as input of various set values and selection of various modes.

In addition, light-emitting unit 10 is rotatably coupled to top side 9a of strobe body unit 9. Further, imaging apparatus 1 illustrated in FIG. 1 is connectably provided on bottom side 9b of strobe body unit 9. In that case, strobe body unit 9 is coupled to imaging apparatus 1 so that front 9c of strobe body unit 9 faces in capturing direction A (an optical axis direction of an imaging lens) of imaging apparatus 1.

In addition, light-emitting unit 10 is made of, for example, a substantially rectangular housing or a rectangular housing, with one surface of the housing provided with opening portion 10a for radiating the light emitted from flash discharge tube 11. Further, light-emitting unit 10 is configured to allow irradiating direction C for emitting strobe light to be changed in response to change in an inclination angle and an orientation of opening portion 10a in vertical direction B.

In addition, variable mechanism 12 includes vertical-direction variable mechanism 18 and horizontal-direction variable mechanism 19 as illustrated in FIG. 4A and FIG. 4B and rotatably couples strobe body unit 9 with light-emitting unit 10. Specifically, vertical-direction variable mechanism 18 of variable mechanism 12 is coupled to strobe body unit 9 so that vertical-direction variable mechanism 18 is able to rotate in vertical direction B on horizontal shaft X which is provided in strobe body unit 9 in width direction D illustrated in FIG. 3. On the other hand, horizontal-direction variable mechanism 19 of variable mechanism 12 is coupled to strobe body unit 9 so that horizontal-direction variable mechanism 19 is able to rotate in horizontal direction F on vertical shaft Y which is provided in strobe body unit 9 in up and down direction E (height direction: see FIG. 4A).

Further, as illustrated in FIG. 4A, vertical-direction variable mechanism 18 of variable mechanism 12 is provided to be able to change an angle and an orientation of light-emitting unit 10 in vertical direction B. Specifically, vertical-direction variable mechanism 18 is provided to couple strobe body unit 9 with light-emitting unit 10 so that vertical-direction variable mechanism 18 is able to rotate the angle and the orientation of light-emitting unit 10 in vertical direction B designated by a solid line in FIG. 4A between a usual irradiating direction angle (an angle of light-emitting unit 10 at usual capturing position P1) and desired irradiating direction angles (angles of light-emitting unit 10 at bounce photography position P2 and bounce photography position P3) designated by alternate long and short dash lines in FIG. 4A which are set by the user and different from the usual irradiating direction angle. In the present exemplary embodiment, vertical-direction variable mechanism 18 of variable mechanism 12 rotates between usual capturing position P1 and bounce photography position P3 within a rotation angle range of, for example, 180 degrees in a vertical direction.

On the other hand, as illustrated in FIG. 4B, horizontal-direction variable mechanism 19 of variable mechanism 12 is provided to be able to change an angle and an orientation of light-emitting unit 10 in horizontal direction F. Further, in the present exemplary embodiment, horizontal-direction variable mechanism 19 has a rotating angle of 180 degrees in a left and right direction.

In addition, as illustrated in FIG. 2 and FIG. 3, driving unit 13 is provided with vertical-direction driving unit 20 (see, FIG. 3) which is made of, for example, a vertical-direction driving motor and the like and configured to drive vertical-direction variable mechanism 18 to rotate, and also provided with horizontal-direction driving unit 21 (see, FIG. 2) which is made of, for example, a horizontal-direction driving motor and the like and configured to drive horizontal-direction variable mechanism 19 to rotate.

In addition, angle detection unit 14 is provided on light-emitting unit 10 and includes vertical-direction angle detection unit 22 which is configured to detect an angle of light-emitting unit 10 in vertical direction B and horizontal-direction angle detection unit 23 which is configured to detect an angle of light-emitting unit 10 in horizontal direction F.

In this case, in the present exemplary embodiment, vertical-direction angle detection unit 22 is made of, for example, three axes acceleration sensor which is configured to detect acceleration in three directions of the x-axis, the y-axis, and the z-axis. Then, vertical-direction angle detection unit 22 detects an inclination angle of light-emitting unit 10 (an angle and an orientation of light-emitting unit 10) in vertical direction B of light-emitting unit 10 by using the three axes acceleration sensor to detect gravitational acceleration of light-emitting unit 10 which is at rest. In the present exemplary embodiment, horizontal-direction angle detection unit 23 is made of a magnetic field sensor which is configured to detect a strength and a direction of a magnetic field (or a field). Then, horizontal-direction angle detection unit 23 detects an inclination angle of light-emitting unit 10 (an angle and an orientation of light-emitting unit 10) in horizontal direction F of light-emitting unit 10 by detecting a compass direction in which light-emitting unit 10 faces.

In addition, control section 15 is provided with arithmetic operation unit 24 which is configured to perform various kinds of arithmetic processing and storage unit 25 which is configured to store various types of information. Control section 15 is made of a CPU, and storage unit 25 is made of a built-in RAM or a built-in ROM of the CPU or a RAM or a ROM externally connected to the CPU.

In addition, distance sensor 17 is, for example, provided on light-emitting unit 10 and configured to concurrently serve as first distance-measuring section 17a and second distance-measuring section 17b to be described later.

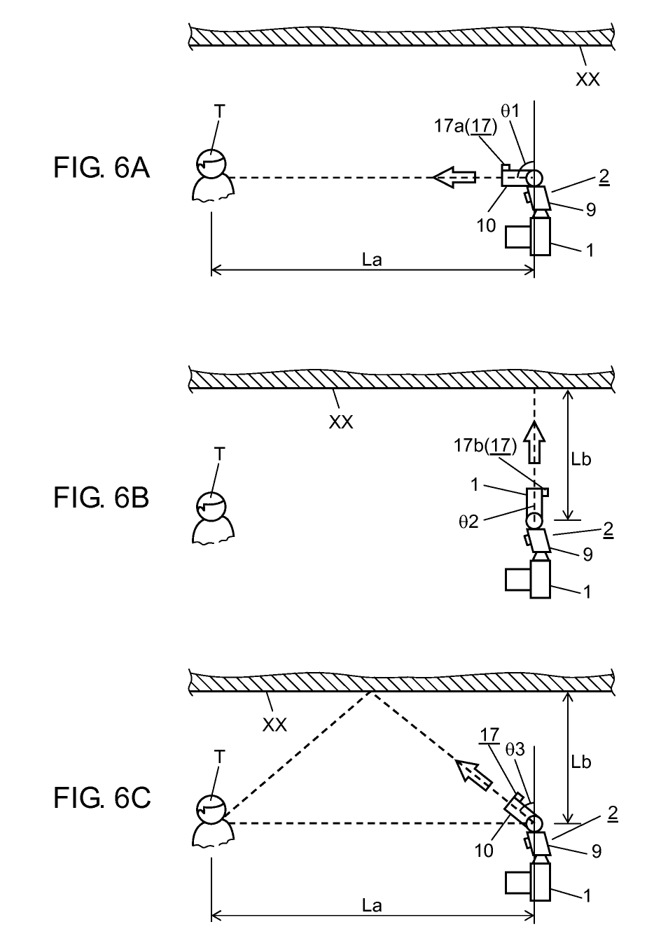

That is, in the case where distance sensor 17 is used as first distance-measuring section 17a, distance sensor 17 acquires distance La between light-emitting unit 10 and subject T as in FIG. 6A. On the other hand, in the case where distance sensor 17 is used as second distance-measuring section 17b, distance sensor 17 acquires distance Lb between light-emitting unit 10 and a reflective object such as ceiling XX (see, FIG. 6B).

Then, in the case where distance sensor 17 is used as first distance-measuring section 17a, distance sensor 17 measures distance La between light-emitting unit 10 and subject T as first distance information when the angle of light-emitting unit 10 in a direction perpendicular to the reflective object (a reference direction) is subject angle θ1. On the other hand, in the case where distance sensor 17 is used as second distance-measuring section 17b, distance sensor 17 measures distance Lb between light-emitting unit 10 and the reflective object as second distance information when the angle of light-emitting unit 10 in the reference direction is angle θ2 toward the reflective object. It should be noted that distance sensor 17 does not need to concurrently serve as first distance-measuring section 17a and second distance-measuring section 17b by itself and different distance sensors may be used for the first distance-measuring and for the second distance-measuring.

In addition, control section 15 has modes for selecting a particular one from among a plurality of reflective objects and controls light-emitting unit 10 and so on based on the selected mode.

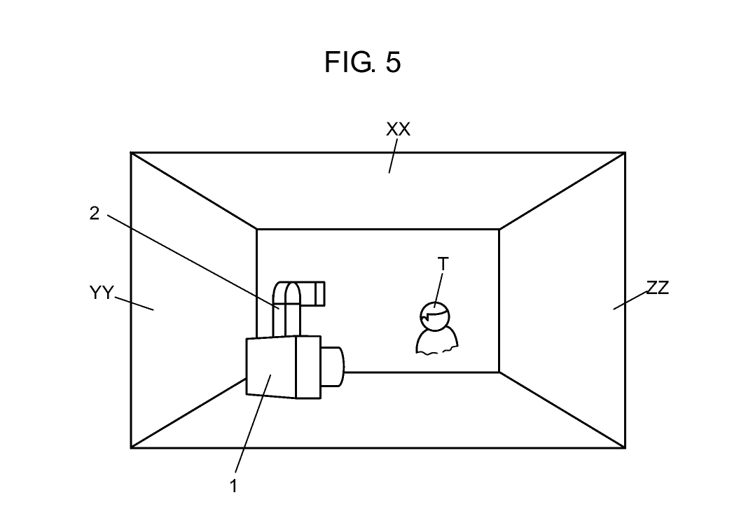

Specifically, in the present exemplary embodiment, as illustrated in FIG. 5, any one of three reflective objects of ceiling XX, left wall YY, and right wall ZZ is a mode of control section 15 that can be selected. In that case, the modes for the user to select a reflective object are implemented by a user interface or the like on operating unit 16 of strobe body unit 9.

Hereinbelow, calculation of a bounce angle and setting of the angle of light-emitting unit 10 to the bounce angle in the case where the mode of setting ceiling XX as the reflective object is selected in the strobe device of the present exemplary embodiment will be described with reference to drawings from FIG. 6A to FIG. 6C.

FIG. 6A is a diagram illustrating a vertical-direction angle of a light-emitting unit of the strobe device according to the exemplary embodiment in measuring the first distance. FIG. 6B is a diagram illustrating a vertical-direction angle of the light-emitting unit of the strobe device according to the exemplary embodiment in measuring the second distance. FIG. 6C is a diagram illustrating a vertical-direction angle of the light-emitting unit of the strobe device according to the exemplary embodiment in performing the bounce photography.

First, as illustrated in FIG. 6A, a photographer aligns an optical axis direction of a capturing lens of imaging apparatus 1 with subject T and presses shutter 8 halfway. In response to the half-pressing, control unit 4 of imaging apparatus 1 sends a signal for starting the bounce photography to control section 15 of strobe device 2.

In response to reception of the signal, control section 15 of strobe device 2 drives vertical-direction variable mechanism 18 by using vertical-direction driving unit 20 to change the angle of light-emitting unit 10 in vertical direction B. At that moment, control section 15 changes the angle of light-emitting unit 10 in vertical direction B to angle θ1 toward the subject based on the angle of light-emitting unit 10 in vertical direction B detected by vertical-direction angle detection unit 22.

When the angle of light-emitting unit 10 has changed to angle θ1, distance sensor 17 as first distance-measuring section 17a measures first distance La between light-emitting unit 10 and subject T. In that manner, first distance La has been measured.

Next, as illustrated in FIG. 6B, control section 15 of strobe device 2 drives vertical-direction variable mechanism 18 by using vertical-direction driving unit 20 toward ceiling XX, which is selected as the mode of reflective object, to change the angle of light-emitting unit 10 in vertical direction B. At that moment, control section 15 changes the angle of light-emitting unit 10 in vertical direction B to angle θ2 toward the reflective object based on the angle of light-emitting unit 10 in vertical direction B detected by vertical-direction angle detection unit 22.

When the angle of light-emitting unit 10 has changed to angle θ2, distance sensor 17 as second distance-measuring section 17b measures second distance Lb between light-emitting unit 10 and ceiling XX. In that manner, second distance Lb has been measured.

Next, arithmetic operation unit 24 in control section 15 of strobe device 2 calculates bounce angle θ3 based on information about first distance La and second distance Lb. Incidentally, bounce angle θ3 is, for example, an angle causing an incidence angle of strobe light onto the reflective object and emergence angle of reflected light from the reflective object to be the same.

Next, based on calculated bounce angle θ3, control section 15 of strobe device 2 drives vertical-direction variable mechanism 18 by using vertical-direction driving unit 20 to change the angle of light-emitting unit 10 in vertical direction B. At that moment, control section 15 changes the angle of light-emitting unit 10 in vertical direction B to bounce angle θ3 based on the angle of light-emitting unit 10 in vertical direction B detected by vertical-direction angle detection unit 22.

The above described distance-measurement of first distance La, distance-measurement of second distance Lb, and changing of bounce angle θ3 are automatically performed by control section 15 of strobe device 2, so that light-emitting unit 10 is controlled.

When bounce angle θ3 has been set as described above, the photographer presses shutter 8 completely down. As a result, light-emitting unit 10 of strobe device 2 emits light and the bounce photography is performed on subject T.

In other words, first, arithmetic operation unit 24 in control section 15 of strobe device 2 according to the present exemplary embodiment calculates bounce angle θ3 based on first distance La which has been acquired by first distance-measuring section 17a and second distance Lb which has been acquired by second distance-measuring section 17b.

Then, control section 15 controls vertical-direction driving unit 20 to cause the angle of light-emitting unit 10 in vertical direction B to be bounce angle θ3 based on bounce angle θ3 calculated by arithmetic operation unit 24, and angular information of light-emitting unit 10 in vertical direction B, acquired by vertical-direction angle detection unit 22, regardless of the current angle and orientation of light-emitting unit 10. As a result, control section 15 can correctly set light-emitting unit 10 of strobe device 2 to bounce angle θ3 and perform the bounce photography.

Meanwhile, although the above described exemplary embodiment has been illustrated by taking a case where ceiling XX is selected as the mode of reflective object as an example, the present invention is not limited to that. For example, as illustrated in FIG. 5, the user may select the different reflective object such as left wall YY or right wall ZZ may be selected as the mode and perform bounce photography. In that case, it is only required to replace above described vertical-direction variable mechanism 18 by horizontal-direction variable mechanism 19, vertical-direction driving unit 20 by horizontal-direction driving unit 21, vertical-direction angle detection unit 22 and vertical direction B by horizontal-direction angle detection unit 23 and horizontal direction F to cause control section 15 of strobe device 2 to control light-emitting unit 10, a detailed description of that case will be omitted. As a result, the user can also select the different reflective object such as left wall YY or right wall ZZ as the mode and correctly perform bounce photography at bounce angle θ3.

With strobe device 2 of the present exemplary embodiment, any of a plurality of different reflective objects to be used in the bounce photography is selected as the mode, therefore, options in the bounce photography can be increased. Therefore, the user can perform bounce photography on a favorable image of a subject or perform bounce photography in preferable irradiating conditions of strobe light.

In addition, with strobe device 2 of the present exemplary embodiment, when selecting a reflective object of different mode, control section 15 calculates the bounce angle on the basis of the selected reflective object. At the same time, control section 15 automatically controls the angle of light-emitting unit 10 based on the bounce angle newly calculated for the selected reflective object. As a result, the imaging apparatus is ready to perform bounce photography without missing a chance for a good shot. Therefore, the strobe device which is able to capture an image of a subject in a more preferable state and the imaging apparatus provided with the strobe device can be realized.

Meanwhile, it is needless to say that the strobe device and the imaging apparatus including the strobe device according to the present exemplary embodiment are not limited to the above described exemplary embodiment, and the strobe device and the imaging apparatus may be subjected to various changes without departing from the spirit of the present invention.

As described above, the present invention is a strobe device for bounce photography which is a technique of capturing an image of a subject by irradiating a reflective object with strobe light to irradiate the subject with the reflected light. The strobe device has a strobe body unit, a light-emitting unit rotatably coupled to the strobe body unit, a variable mechanism configured to change an angle and an orientation of the light-emitting unit with respect to the strobe body unit, a driving unit configured to drive the variable mechanism, and a control section configured to control the driving unit. The control section may include modes for selecting a particular one from among a plurality of reflective objects and an arithmetic operation unit configured to calculate a bounce angle of the light-emitting unit with respect to the reflective object selected by using the modes, and may control the driving unit to cause the angle of the light-emitting unit to be the bounce angle.

With the above described configuration, the control section controls the driving unit so that the driving unit drives the variable mechanism to change the angle and the orientation of the light-emitting unit. Then, the control section calculates the bounce angle with respect to the particular reflective object of the selected mode and automatically changes the angle and the orientation of the light-emitting unit based on the bounce angle. Further, when the user has selected the reflective object of another mode, the control section calculates the bounce angle with respect to the reflective object of the new mode and automatically changes the angle and the orientation of the light-emitting unit based on the new bounce angle. In that manner, the imaging apparatus is ready to perform bounce photography without missing a chance for a good shot. As a result, the imaging apparatus which is able to capture an image of a subject in a more preferable state can be realized.

In addition, the strobe device according to the present invention further includes: a first distance-measuring section provided on the strobe body unit, the light-emitting unit, or the imaging apparatus and configured to acquire distance information between the strobe body unit, the light-emitting unit, or the imaging apparatus and the subject as first distance information; a second distance-measuring section provided on the light-emitting unit and configured to acquire distance information between the light-emitting unit and a selected one of the reflective objects as second distance information; and an angle detection unit provided on the strobe body unit or the light-emitting unit and configured to acquire angular information of the light-emitting unit. The arithmetic operation unit may calculate the bounce angle of the light-emitting unit based on the first distance information and the second distance information, and the control section may control the driving unit to cause the angle of the light-emitting unit to be the bounce angle based on the bounce angle and the angular information of the light-emitting unit.

With that configuration, the arithmetic operation unit calculates bounce angle based on the first distance which has been acquired by the first distance-measuring section and the second distance which has been acquired by the second distance-measuring section. Then, the control section controls the driving unit to cause the angle of the light-emitting unit to be the bounce angle based on the bounce angle calculated by the arithmetic operation unit and the angular information of the light-emitting unit acquired by the angle detection unit regardless of the current angle and orientation of the light-emitting unit. In that manner, the control section can set the light-emitting unit to the correct bounce angle.

In addition, in the strobe device according to the present invention, the reflective object may be selected at least from a ceiling and a wall.

With that configuration, in the case where the ceiling is selected as the reflective object, the angle of the light-emitting unit is set based on the bounce angle with the ceiling as a reference. On the other hand, in the case where the wall is selected as the reflective object, the angle of the light-emitting unit is set based on the bounce angle with the wall as a reference. Incidentally, in the case where the wall is used as the reference for the setting of the bounce angle, the wall can be selected from the left wall and the right wall from the viewpoint of the photographer. Therefore, by increasing options for the reflective object, the imaging apparatus can perform bounce photography in preferable conditions.

Further, the imaging apparatus of the present invention has the above described strobe device. Therefore, the imaging apparatus is ready to perform bounce photography by using an optional reflective object. As a result, the imaging apparatus which is able to capture a favorable image of a subject or to capture an image of a subject in more preferable irradiating conditions of strobe light can be realized.

### INDUSTRIAL APPLICABILITY

The present invention is useful for applications in the strobe device that is desired to perform bounce photography to capture a more favorable image of a subject or to capture an image of a subject in more preferable irradiating conditions of strobe light by increasing options for the reflective object to be used in the bounce photography, and the imaging apparatus provided with the strobe device.

### REFERENCE MARKS IN THE DRAWINGS

1 imaging apparatus
2 strobe device
3 capturing function unit
4 control unit
5 display unit
6 operation unit
7 peripheral I/F
8 shutter
9 strobe body unit
9a top side
9b bottom side
9c front
9d back side
10 light-emitting unit
10a opening portion
11 flash discharge tube
12 variable mechanism
13 driving unit
14 angle detection unit
15 control section
16 operating unit
17 distance sensor
17a first distance-measuring section
17b second distance-measuring section
18 vertical-direction variable mechanism
19 horizontal-direction variable mechanism
20 vertical-direction driving unit
21 horizontal-direction driving unit
22 vertical-direction angle detection unit
23 horizontal-direction angle detection unit
24 arithmetic operation unit
25 storage unit
27 main capacitor

1. A strobe device for bounce photography configured to capture an image of a subject by irradiating a reflective object with strobe light to irradiate the subject with reflected light, the strobe device comprising:
a strobe body unit;
a light-emitting unit rotatably coupled to the strobe body unit;
a variable mechanism configured to change an angle and an orientation of the light-emitting unit with respect to the strobe body unit;
a driving unit configured to drive the variable mechanism; and
a control section configured to control the driving unit, wherein the control section includes: modes for selecting a particular one from among a plurality of the reflective objects; and an arithmetic operation unit configured to calculate a bounce angle of the light-emitting unit with respect to the reflective object selected by using the modes, and the control section controls the driving unit to cause an angle of the light-emitting unit to be the bounce angle.

2. The strobe device according to claim 1, further comprising:
a first distance-measuring section provided on the strobe body unit, the light-emitting unit, or the imaging apparatus and configured to acquire distance information between the strobe body unit, the light-emitting unit, or the imaging apparatus and the subject as first distance information;
a second distance-measuring section provided on the light-emitting unit and configured to acquire distance information between the light-emitting unit and a selected one of the reflective objects as second distance information; and
an angle detection unit provided on the strobe body unit or the light-emitting unit and configured to acquire angular information of the light-emitting unit,
wherein the arithmetic operation unit calculates the bounce angle of the light-emitting unit based on the first distance information and the second distance information, and
the control section controls the driving unit to cause the angle of the light-emitting unit to be the bounce angle based on the bounce angle and the angular information of the light-emitting unit.

3. The strobe device according to claim 1, wherein the reflective object is selected at least from a ceiling and a wall.

4. An imaging apparatus comprising the strobe device according to claim 1.

5. The strobe device according to claim 2, wherein the reflective object is selected at least from a ceiling and a wall.
